(19) United States
(12) Patent Application Publication
(10) Pub. No.: US 2016/0182751 A1
(43) Pub. Date: Jun. 23, 2016

(54) IMPOSITION CONTROL PROGRAM, IMAGE PROCESSING APPARATUS, AND IMPOSITION CONTROL METHOD

(71) Applicant: KONICA MINOLTA INC., Tokyo (JP)

(72) Inventor: Yuji KIDO, Tokyo (JP)

(73) Assignee: KONICA MINOLTA INC., Tokyo (JP)

(21) Appl. No.: 14/971,421

(22) Filed: Dec. 16, 2015

(30) Foreign Application Priority Data
Dec. 17, 2014 (JP) 2014-254682

(51) Int. Cl. H04N 1/00; G06K 15/02; G06F 3/12

(52) U.S. Cl. CPC H04N 1/00567; G06F 3/1208; G06F 3/1252; H04N 1/0032; G06K 15/02; H04N 2201/0094

(57) ABSTRACT

A non-transitory recording medium storing a computer readable imposition control program operating in a device that processes a printing job for positioning identical images aligned in 2×2 or more on an identical sheet and cutting the sheet to produce printed materials, the program causes the device to execute: a first process for determining a layout of the images on each of a front surface and a rear surface of the sheet; and a second process for generating printing instruction information for allowing a printing unit to execute printing the images on the front surface and the rear surface of the sheet, wherein the first process positions the image at one corner in a particular diagonal direction on the front surface of the sheet, and the first process positions the image at the one corner in the particular diagonal direction on the rear surface of the sheet.

The entire disclosure of Japanese Patent Application No. 2014-254682 filed on Dec. 17, 2014 including description, claims, drawings, and abstract are incorporated herein by reference in its entirety.

### BACKGROUND OF THE INVENTION

1. Field of the Invention

The present invention relates to an imposition control program, an image processing apparatus, and an imposition control method, and more particularly to an imposition control program, an image processing apparatus, and an imposition control method for controlling a layout of images formed by repeat printing for positioning a plurality of identical images on an identical sheet.

2. Description of the Related Art

An image forming apparatus in recent years includes a function for positioning a plurality of identical images on a single sheet (function of imposition) (hereinafter referred to as repeat printing function) to efficiently produce a plurality of booklets from a smaller number of sheets printed by using this function and cut after printing. However, when a sheet contains images formed in left and right areas of the sheet by using the repeat printing function, a cutting finish in a left copy produced after cutting may be different from a cutting finish in a right copy (i.e., cutting position in the left copy may be different from cutting position in the right copy). In this case, appearances of respective printed materials do not become uniform, wherefore a collective bookbinding process is difficult to perform.

For overcoming this problem, for example, JP 2005-020587 A discloses an image forming apparatus which includes an imposition function for positioning a plurality of document images having identical contents on an identical printing sheet. This image forming apparatus includes an operation unit which specifies a binding position for each document image at the time of bookbinding where two booklets having an identical image constitution are produced by printing image groups constituted by a plurality of document images in a manner that two document images having identical contents are positioned on an identical printing sheet, cutting the printing sheet between the document images after printing, and binding the cut and separated printing sheets at an end of upper, lower, left, or right side of each document image for each of the groups of the document images. The image forming apparatus further includes an image control unit which generates printing data for positioning two document images having identical contents in a manner that the specified binding position on each of the printing sheets is disposed at an end facing a cutting position of the corresponding printing sheet.

When two identical images are positioned on a sheet, cutting finishes in the left and right copies are unified (i.e., the cutting position in the left copy is equalized with the cutting position in the right copy, or the cutting position in the right copy is equalized with the cutting position in the left copy) by rotating one of the images through 180 degrees, as described in JP 2005-020587 A.

However, when identical images aligned in 2×2 or more are positioned on a sheet, such as a case when four identical images aligned in 2×2 on a sheet (4-repeat), or when nine identical images aligned in 3×3 on a sheet (9-repeat), cutting finishes in respective copies are difficult to unify only by rotation of the images through 180 degrees.

When four identical images are positioned on a square sheet, cutting finishes in respective copies are unified by sequential rotation of the respective images through 90 degrees. However, when a rectangular sheet is used, cutting finishes in respective copies are difficult to unify. Moreover, when margins in upper, lower, left, and right areas of a sheet are formed such that the margin in the upper area is different from the margin in the lower area, or that the margin in the left area is different from the margin in the right area, cutting finishes of the respective copies are difficult to unify even in the case of imposition of four identical images on the square sheet.

### SUMMARY OF THE INVENTION

The present invention has been developed to solve the aforementioned problems. It is a chief object of the present invention to provide an imposition control program, an image processing apparatus, and an imposition control method, capable of increasing uniformity of cutting finishes of respective copies without imposing a limitation on a sheet shape or a cutting method, in case of repeat printing performing 4 or more repeats for positioning identical images in 2×2 or more on an identical sheet.

To achieve the abovementioned object, according to an aspect, a non-transitory recording medium storing a computer readable imposition control program operating in a device that processes a printing job for positioning identical images aligned in 2×2 or more on an identical sheet and cutting the sheet between the respective images to produce printed materials each of which contains the corresponding single image, the program reflecting one aspect of the present invention causes the device to execute a first process for determining a layout of the plurality of images on each of a front surface and a rear surface of the sheet, and a second process for generating printing instruction information for allowing a printing unit to execute printing the plurality of images on the front surface and the rear surface of the sheet in accordance with the layout determined in the first process, wherein the first process positions the image in a predetermined direction at one corner in a particular diagonal direction on the front surface of the sheet, and positions the image rotated through 180 degrees at the other corner in the particular diagonal direction on the front surface of the sheet, and the first process positions the image in the predetermined direction at the one corner in the particular diagonal direction on the rear surface of the sheet, and positions the image rotated through 180 degrees at the other corner in the other corner in the particular diagonal direction on the rear surface of the sheet.

To achieve the abovementioned object, according to an aspect, an image processing apparatus that processes a printing job for positioning identical images aligned in 2×2 or more on an identical sheet and cutting the sheet between the respective images to produce printed materials each of which contains the corresponding single image, the image processing apparatus reflecting one aspect of the present invention comprises a rasterizing unit that analyzes the printing job to generate the images for each page, and an imposition setting unit that determines a layout of the plurality of images of an identical page on each of a front surface and a rear surface of the sheet, and generates printing instruction information for allowing printing of the plurality of images on the front surface and the rear surface of the sheet in accordance with the layout determined by the rasterizing unit, wherein at the time of determination of the layout of the plurality of images, the imposition setting unit positions the image in a predetermined direction at one corner in a particular diagonal direction on the front surface of the sheet, and positions the image rotated through 180 degrees at the other corner in the particular diagonal direction on the front surface of the sheet, and at the time of determination of the layout of the plurality of images, the imposition setting unit positions the image in the predetermined direction at the one corner in the particular diagonal direction on the rear surface of the sheet, and positions the image rotated through 180 degrees at the other corner in the other corner in the particular diagonal direction on the rear surface of the sheet.

To achieve the abovementioned object, according to an aspect, an imposition control method for a device that processes a printing job for positioning identical images aligned in 2×2 or more on an identical sheet and cutting the sheet between the respective images to produce printed materials each of which contains the corresponding single image, the method reflecting one aspect of the present invention comprises a first process for determining a layout of the plurality of images on each of a front surface and a rear surface of the sheet, and a second process for generating printing instruction information for allowing a printing unit to execute printing the plurality of images on the front surface and the rear surface of the sheet in accordance with the layout determined in the first process, wherein the first process positions the image in a predetermined direction at one corner in a particular diagonal direction on the front surface of the sheet, and positions the image rotated through 180 degrees at the other corner in the particular diagonal direction on the front surface of the sheet, and the first process positions the image in the predetermined direction at the one corner in the particular diagonal direction on the rear surface of the sheet, and positions the image rotated through 180 degrees at the other corner in the other corner in the particular diagonal direction on the rear surface of the sheet.

### BRIEF DESCRIPTION OF THE DRAWINGS

The above and other objects, advantages and features of the present invention will become more fully understood from the detailed description given hereinbelow and the appended drawings which are given by way of illustration only, and thus are not intended as a definition of the limits of the present invention, and wherein:

FIG. 1 is a block diagram illustrating a configuration of a printing system according to Example 1 of the present invention;

FIG. 2 is a flowchart illustrating operation of the printing system according to Example 1 of the present invention;

FIGS. 3A and 3B are views illustrating an example of a printing setting screen displayed by a printer driver of a user terminal according to Example 1 of the present invention;

FIG. 4 is a view illustrating an example of 4-repeat printing (cutting position: left and upper sides of an image) according to Example 1 of the present invention;

FIG. 5 is a view illustrating an example of 4-repeat printing (cutting position: right and upper sides of an image) according to Example 1 of the present invention;

FIG. 6 is a view illustrating an example of 4-repeat printing (cutting position: left and lower sides of an image) according to Example 1 of the present invention;

FIG. 7 is a view illustrating an example of 4-repeat printing (cutting position: right and lower sides of an image) according to Example 1 of the present invention;

FIG. 8 is a view illustrating an example of 4-repeat printing (imposition of images for 2 pages) according to Example 1 of the present invention;

FIG. 9 is a view illustrating an example of 4-repeat printing (imposition of images for a plurality of pages) according to Example 1 of the present invention;

FIG. 10 is a view illustrating another example of 4-repeat printing (imposition of images for a plurality of pages) according to Example 1 of the present invention;

FIGS. 11A through 11D are views illustrating 8-repeat printing according to Example 2 of the present invention in comparison with a conventional method;

FIGS. 12A through 12H are views illustrating 9-repeat printing according to Example 2 of the present invention in comparison with a conventional method;

FIG. 13 is a view illustrating conventional 2-repeat printing;

FIG. 14 is a view illustrating 2-repeat printing of JP 2005-020587 A;

FIG. 15 is a view illustrating conventional 4-repeat printing (square sheet); and

FIG. 16 is a view illustrating conventional 4-repeat printing (rectangular sheet)

### DESCRIPTION OF THE PREFERRED EMBODIMENTS

Hereinafter, an embodiment of the present invention will be described with reference to the drawings. However, the scope of the invention is not limited to the illustrated examples.

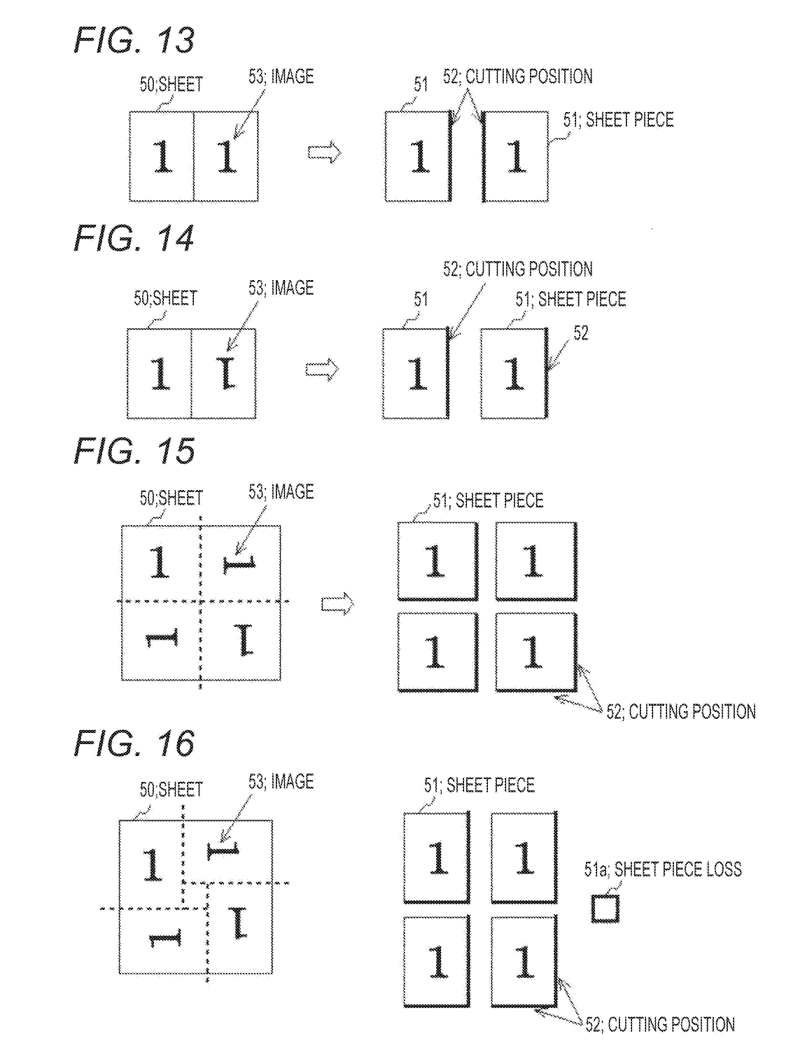

As described in the section of “Description of the Related Art”, an image forming apparatus in recent years includes the repeat printing function which positions a plurality of identical images on a single sheet. When a sheet 50 is cut at the center in the process of 2-repeat printing for positioning two identical images by using the repeat printing function, in such a state that two images 53 (each indicated as “1” in the figure) are disposed in an identical direction as illustrated, in FIG. 13, a cutting position 52 (portion indicated by a bold solid line) produced in a left copy (sheet piece 51) is disposed at a position different from the cutting position 52 produced in a right copy (sheet piece 51). In this case, cutting finishes are difficult to unify. For overcoming this problem, the image forming apparatus disclosed in JP 2005-020587 A unifies the cutting finishes by rotating one of the images 53 through 180 degrees and equalizing the cutting position 52 (sheet pieces 51) in the left or right copy (sheet pieces 51) to the cutting position 52 of the opposite copy as illustrated in FIG. 14.

In case of 2-repeat printing which positions two identical images, cutting finishes are unified for sheets having arbitrary shapes (such as rectangular sheet and square sheet) by using the foregoing method. However, when identical images aligned in 2×2 or more are positioned, elaboration in view of the sheet shape and the cutting method is required to unify the cutting finishes. For example, when four identical images are positioned on a square sheet, cutting finishes are unified by rotating each of the images 53 through 90 degrees and forming the cutting positions 52 at the same positions (right and lower positions in the figure) for all of the sheet pieces 51 as illustrated in FIG. 15. In this case, however, the shape of the sheet 50 is limited to this particular shape. In case of imposition of four identical images on a rectangular sheet, a die-cut process producing halfway cuts in the sheet 50 is employed to unify cutting finishes as illustrated in FIG. 16. In this case, however, the cutting method is limited to this particular method, and a sheet piece loss 51a is produced. Moreover, while it is assumed that identical margins are provided in the upper and lower areas and in the left and right areas of the sheet 50 in the examples illustrated in FIGS. 14 through 16, the sheet 50 may include different margins in the upper and lower areas or in the left and right areas. In this case, the positions of the images 53 on the respective sheet pieces 51 are difficult to unify.

For solving these problems, identical images which have been positioned only on one surface of a sheet in the foregoing method are separately positioned on each of the front and rear surfaces of the sheet according to an embodiment of the present invention. Concerning four images positioned in respective corners of the sheet, the images are positioned in two corners of the front surface of the sheet in one diagonal direction while rotated through 180 degrees with respect to each other. On the other hand, the images are positioned in two corners of the rear surface of the sheet in the same diagonal direction while rotated through 180 degrees with respect to each other.

For example, in case of imposition of four images, the image in a particular direction is positioned in the left-upper area (or right-upper area) of the front surface of the sheet, while the image rotated through 180 degrees with respect to the particular direction is positioned in the right-lower area (or left-lower area) of the front surface of the sheet. On the other hand, the image in the particular direction is positioned in the left-upper area (or right-upper area) of the rear surface of the sheet, while the image rotated through 180 degrees with respect to the particular direction is positioned in the right-lower area (or left-lower area) of the rear surface of the sheet. In other words, two images are disposed in the same diagonal areas of four equal divisions of the sheet divided in 2×2 in the longitudinal direction and the transverse direction on each of the front and rear surfaces of the sheet. Moreover, the directions of the images in the upper area (left area) and the lower area (right area) are rotated through 180 degrees with respect to each other. This method unifies the cutting finishes of all the four copies.

According to more generalized description of this method, in case of imposition of identical images aligned in 2×2 or more, two of our images positioned at four corners of equal divisions of a sheet are disposed at the same diagonal positions on each or the front and rear surfaces of the sheet. In addition, the directions of the images in the upper area (left area) and in the lower area (right area) are rotated through 180 degrees with respect to each other. This method unifies cutting finishes, or reduces the number of cutting finish patterns. Accordingly, appearances of printed materials improve.

### EXAMPLE 1

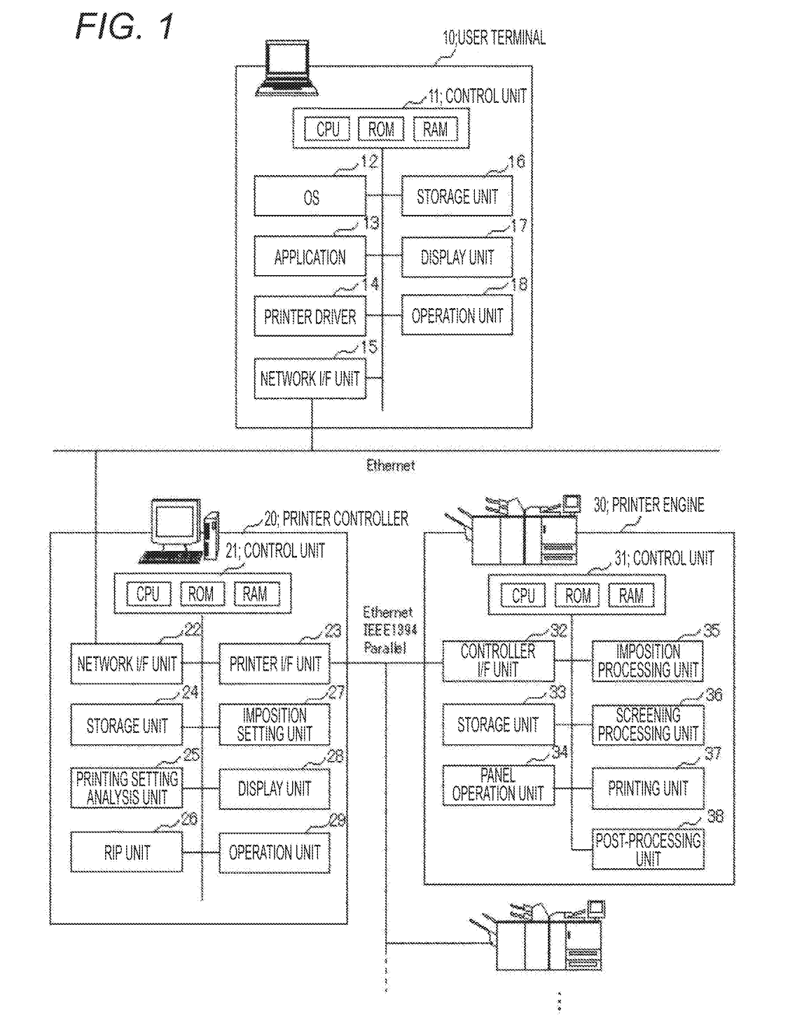

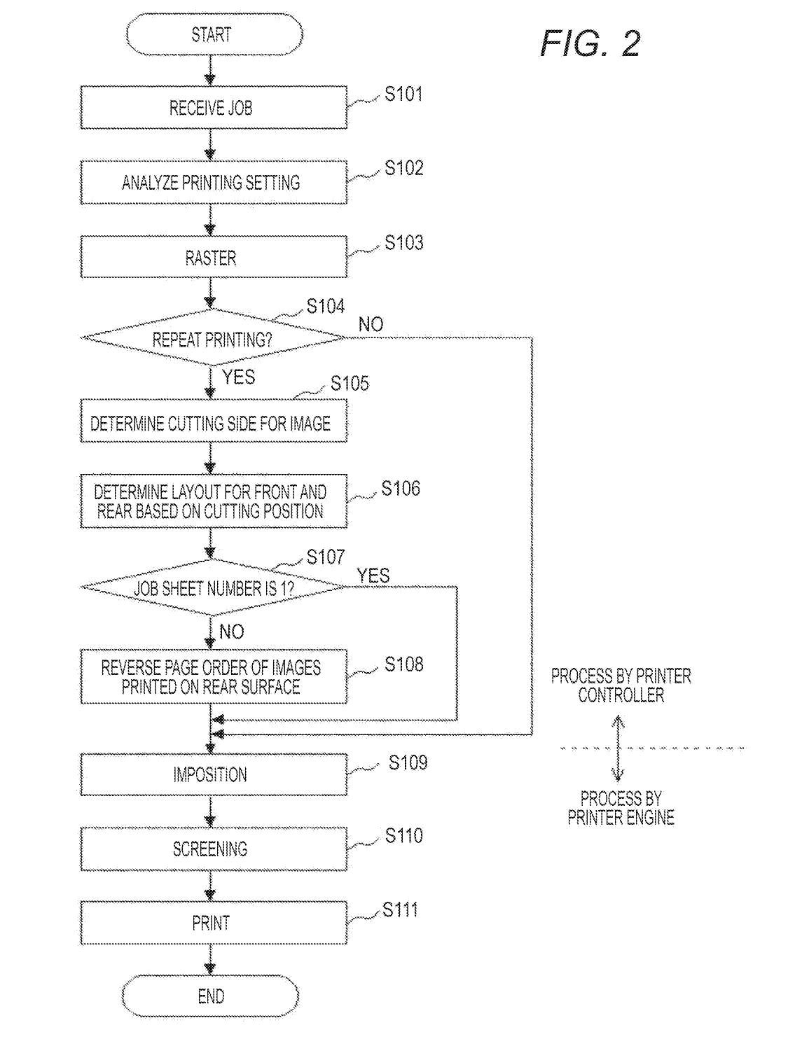

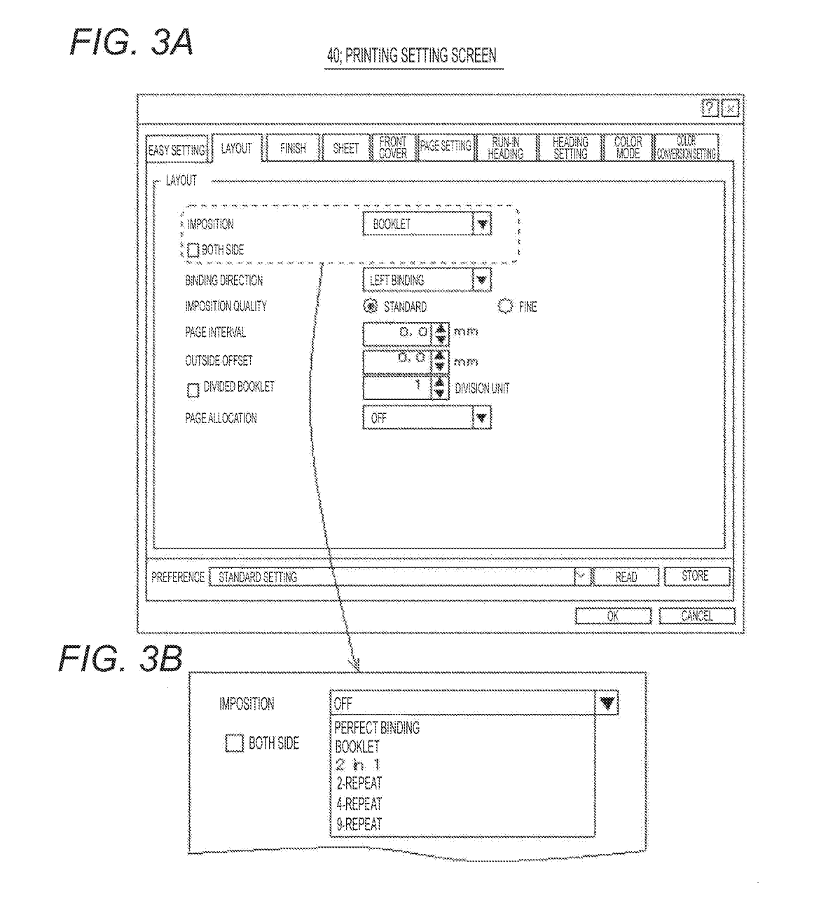

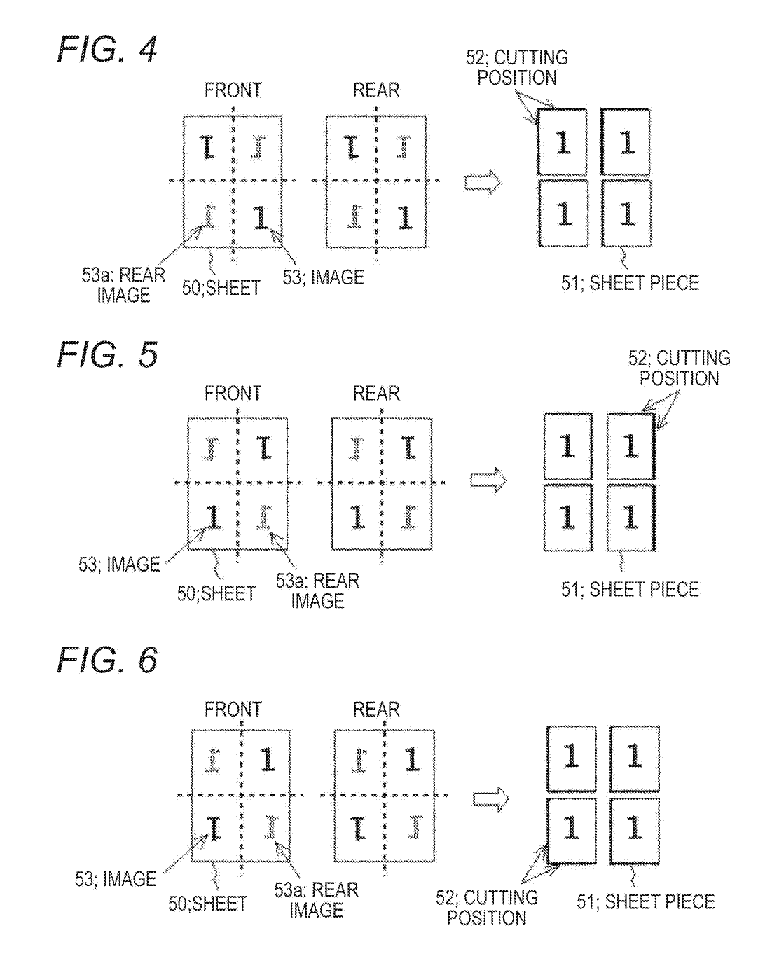

An imposition control program, an image processing apparatus, and an imposition control method according to Example 1 of the present invention are hereinafter described with reference to FIGS. 1 through 13 to further detail the embodiment of the present invention discussed above. FIG. 1 is a block diagram illustrating a configuration of a printing system according to Example 1. FIG. 2 is a flowchart illustrating operation of the printing system. FIGS. 3A and 3B illustrate an example of a printing setting screen of a printer driver. FIGS. 4 through 10 are views illustrating specific examples of 4-repeat printing.

As illustrated in FIG. 1, a printing system according to Example 1 includes a user terminal 10, a printer controller 20, and a printer engine 30, provided on an intranet and connectable with each other via a communication network. According to this structure, Ethernet (registered trademark) or the like may be adopted as a standard of the communication network. However, data transfer from the printer controller 20 to the printer engine 30 may be realized by using IEEE1394 Parallel or the like, instead of Ethernet (registered trademark). According to the example illustrated in FIG. 1, the printer controller 20 is provided separately from the printer engine 30. However, the printer controller 20 may be contained within the printer engine 30. Details of respective devices are hereinafter described.

[User Terminal]

The user terminal 10 is a computer device such as a personal computer, and issues a printing instruction to the printer engine 30 via the printer controller 20. The user terminal 10 includes a control unit 11, an OS (operating system) 12, an application 13, a printer driver 14, a network I/F unit 15, a storage unit 16, a display unit 17, an operation unit 18, and others.

The control unit 11 is constituted by a CPU (center processing unit), and memories such as ROM (read only memory) and PAM (random access memory). The CPU loads a control program stored in the RCM or the storage unit 16 into the RAM, and executes the program to control overall operation of the user terminal 10.

The OS 12 constituted by Windows (registered trademark) or Macintosh (registered trademark), for example, enables operation of the application 13 and the printer driver 14 of the user terminal 10.

The application 13 is software for producing documents, or performing spreadsheet processing or image processing, for example. The application 13 reads the printer driver 14 at the time of issue of a printing instruction, and transfers data generated by the application 13 (hereinafter referred to as document data) to the printer driver 14.

The printer driver 14 is printing control software which converts document data generated by the application 13 into a printing job in a language readable by the printer controller 20 (PDL (page description language) data described in a page description language such as PJL (printer job language), PS (postscript) and PCL, (printer control language) or PDF (portable document format) data). Printing setting information set through a printing setting screen of the printer driver 14 is added to the printing job.

The network I/F unit 15 constituted by an NIC (network interface card), a modem or the like connects the user terminal 10 to the communication network, and transmits a printing job to the printer controller 20.

The storage unit 16 constituted by an HDD (hard disk driver), an SSD (solid state driver) or the like stores a program executed by the CPU for controlling respective units, information about processing functions of the user terminal 10, document data generated by the application 13, a printing job generated by the printer driver 14, and others.

The display unit 17 constituted by a liquid crystal display device (LCD: liquid crystal display), an organic EL (electroluminescence) display device or the like displays a document producing screen of the application 13, the printing setting screen of the printer driver 14, and others. The printing setting screen of the printer driver 14 has a configuration illustrated in FIG. 3A, for example. This screen shows setting items classified in accordance with tabs. When a tab associated with layout is selected through the screen, items such as imposition, binding, and page layout become selectable. FIG. 3B is an enlarged view illustrating the item of imposition. The pulldown menu of this item includes “perfect binding” which folds each of sheets containing printing on both surfaces in half, sequentially overlaps the respective sheets, and binds the overlapped sheets, “booklet” which overlaps a plurality of sheets each containing printing on both surfaces, folds the sheets in half, and binds the folded sheets, “2 in 1” which positions images for two pages in each of sheets, “2-repeat” which positions two images of each page on each of sheets, “4-repeat” which positions four images of each page on each of sheets, and “9-repeat” which positions nine images of each page on each of sheets, for example. These functions are selectable through the display.

The operation unit 18 constituted by a mouse, a keyboard or the like enables operations such as generation of a document by using the application 13, and setting for printing (including setting of imposition function) by using the printer driver 14.

When the printer controller 20 is configured to automatically execute a printing job in particular format (such as PDF data) in response to storage of this printing job in a predetermined folder of the printer controller 20, file copy to the predetermined folder may be made, for example, to issue a printing instruction to the printer engine 30.

[Printer Controller]

The printer controller 20 is a device (image processing apparatus) for controlling the printer engine 30 in accordance with an instruction from the user terminal 10. The printer controller 20 includes a control unit 21, a network I/F unit 22, a printer I/F unit 23, a storage unit 24, a printing setting analysis unit 25, an RIP (raster image processor) unit 26, an imposition setting unit 27, and others. The printer controller 20 further includes a display unit 28 and an operation unit 29 as necessary.

The control unit 21 constituted by a CPU and memories such as ROM and Ram loads a control program stored in the ROM or the storage unit 24 into the RAM, and executes the control program to control overall operation of the printer controller 20.

The network I/F unit 22 constituted by an NIC, a modem or the like connects the printer controller 20 to the communication network. The printer I/F unit 23 constituted by an NIC, a modem or the like realizes communication with the printer engine 30.

The storage unit 24 constituted by an HDD, an SSD or the like stores a program executed by the CPU for controlling respective units, information about processing functions of the printer controller 20, a printing job received from the user terminal 10, image data generated by the RIP unit 26, and others.

The printing setting analysis unit 25 determines parameters for rasterization (such as size, resolution, and color conversion settings) for a printing job, parameters for (such as screening, layout, and staple) for a rasterized image, and others based on printing setting information contained in a printing job. Particularly, the printing setting analysis unit 25 checks whether or not repeat printing has been designated in a printing job.

The RIP unit 26 analyzes a printing job, and rasterizes each page of the printing job to generate image data for each page.

The imposition setting unit 27 selects cutting positions from upper, lower, left, and right sides of an image of a page, and determines a basic layout of images positioned on front and rear surfaces of a sheet when repeat printing is designated in a printing job. The imposition setting unit 27 further determines whether only one sheet is consumed or two or more sheets are consumed for each copy of a printing job (i.e., needed for processing for one copy of a job) as necessary, and executes a reversing process for reversing the page order of images positioned on the front surface or the rear surface such that the page orders are equalized (ascending order or descending order) for all booklets (sheet pieces) when two or more sheets are consu0med for one copy of the job. Then, the imposition setting unit 27 generates printing instruction information containing the information analyzed by the printing setting analysis unit 25, the layout information, and the page order information as necessary. The imposition setting unit 27 may be constituted by hardware, or an imposition control program executed by the CPU to allow the function of the control unit 21 as the imposition setting unit 27.

The display unit 28 constituted by a liquid crystal display device, an organic EL display device or the like displays various types of setting screens. The operation unit 29 constituted by a mouse, a keyboard or the like enables various types of setting operations and others.

[Printer Engine]

The printer engine 30 is an image forming apparatus such as an MEP (multifunction peripheral) which executes printing in accordance with an instruction received from the printer controller 20. The printer engine 30 forms an image on a designated sheet based on image data received from the printer controller 20. The printer engine 30 includes a control unit 31, a controller I/F unit 32, a storage unit 33, a panel operation unit 34, an imposition unit 35, a screening unit 36, a printing unit 37, a post-processing unit 38, and others.

The control unit 31 constituted by a CPU and memories such as ROM and RAM loads a control program stored in the ROM and the storage unit 33 into the RAM, and executes the control program to control overall operation of the printer engine 30.

The controller I/F unit 32 constituted by an NIC, a modem or the like realizes communication with the printer controller 20, and receives image data and printing instruction. information from the printer controller 20.

The storage unit 33 constituted by an HDD, an SSD or the like stores a program executed by the CPU for controlling respective units, information about processing functions of the printer engine 30, image data and printing instruction information received from the printer controller 20, and others.

The panel operation unit 34 is constituted by a touch panel or the like including a pressure-sensitive operation unit (touch sensor) where transparent electrodes are provided in a grid pattern on a display unit. The panel operation unit 34 displays various types of screens concerning printing processing, and enables various types of operations concerning printing.

The imposition unit 35 positions images of each page formed based on image data received from the printer controller 20 in accordance with layout information contained in the printing instruction information to generate printing image data.

The screening unit 36 executes mask operation in accordance with a screen shape designated in the printing instruction information. The screening unit 36 executes this mask operation for printing image data generated by the imposition unit 35 to produce half-tone images.

The printing unit 37 executes printing operation based on input of images subjected to screening (binary images). In case of an image forming apparatus utilizing an electrophotographic image forming process, for example, the apparatus applies light corresponding to an image to a uniformly charged photosensitive drum to form an electrostatic latent image, applies charged toner to the electrostatic latent image to visualize the electrostatic latent image as a toner image, transfers the toner image to a sheet via intermediate transfer bodies such as a primary transfer roller and a secondary transfer belt, and heats and pressurizes the toner image to fix the toner image to the sheet.

The post-processing unit 38 cuts sheets, forms holes, binds respective cut pieces, and performs bookbinding, for example. Particularly, the post-processing unit 38 cuts sheets on which images are formed by the printing unit 37 in accordance with the printing setting information.

While the imposition setting unit 27 is provided on the printer controller 20 in the example illustrated in FIG. 1, the function of the imposition setting unit 27 (imposition control program) may be realized by the printer engine 30. In this case, the printer controller 20 transmits image data subjected to rasterization to the printer engine 30. The printer engine 30 (such as control unit 31 and imposition unit 35) having received the image data determines cutting positions, and a basic layout of the front and rear surfaces of a sheet, and executes the page order reversing process, and then positions images on the front and rear surfaces of the sheet in accordance with the determined settings.

The function of the imposition setting unit 27 may be realized by the user terminal 10. In this case, the printer driver 14 determines cutting positions, and a basic layout on the front and rear surfaces of a sheet, and executes the page order reversing process based on settings of the printing setting screen. Then, the printer driver 14 adds printing setting information containing these imposition settings to a printing job, and transmits the printing job to the printer controller 20.

While the post-processing unit 38 provided on the printer engine 30 cuts sheets in the example illustrated in FIG. 1, cutting of sheets maybe performed by using a cutting device different from the printer engine 30, or manually performed by a user. In this case, the post-processing unit 38 may be eliminated from the printer engine 30.

Operations executed by the printer controller 20 and the printer engine 30 constructed as above are hereinafter described with reference to FIG. 2. The CPU of the printer controller 20 (or printer engine 30) loads the imposition control program stored in the ROM or the storage unit into the RAM, and executes the imposition control program to perform processes in respective steps illustrated in the flowchart of FIG. 2.

Initially, the printer controller 20 receives a printing job from the user terminal 10 (S101). It is assumed that this printing job is constituted by PDL data as document data, to which printing setting information described in PJL or the like has been added.

The printing setting analysis unit 25 of the printer controller 20 analyzes printing setting information contained in the printing lob to obtain settings of the rasterizing process, settings of image processing and a layout (settings associated with repeat printing, both side printing, and N-up layout) for images subjected to the rasterizing process, settings of the post-processing (settings associated with cutting, staple, and bookbinding), and others (S102).

The RIP unit 26 of the printer controller 20 rasterizes each page included in the printing job in accordance with the settings of the rasterizing process obtained by the printing setting analysis unit 25 to generate image data (S103).

The printer controller 20 determines whether or not repeat printing has been designated in the printing lob based on a setting associated with repeat printing obtained by the printing setting analysis unit 25 (S104). The function of repeat printing may be provided as a choice included in the settings for “imoposition”, “booklet”, “ganging”, and others. In case of the configuration illustrated in FIG. 3B, “2-repeat”, “4-repeat”, and “9-repeat” are regarded as repeat printing. In these functions, advantages of Example 1 are expected in the case of “4-repeat” and “9-repeat”. The function “ganging” is a printing method which executes printing in a state that images associated with a plurality of printing jobs are allocated to an identical sheet.

When repeat printing is not designated, the flow skips to S109. When repeat printing (4-repeat printing in Example 1) is designated, the imposition setting unit 27 of the printer controller 20 selects cutting positions from the upper, lower, left, and right sides relative to an image of a document (S105). More specifically, in case of positioning in 4-repeat printing, a sheet is cut once in each of the longitudinal direction and the transverse direction. In this case, the cutting positions lie in any of “left and upper”, “right and upper”, “left and lower”, and “right and lower” sides of the sheet relative to an image of a document. The cutting positions may be designated directly by the user, or may be determined by the imposition setting unit 27 with reference to staples or binding positions of case binding designated by the user (such as a case when the right and lower cutting positions are determined based on the staple positions in the left and upper area, for example).

The imposition setting unit 27 of the printer controller 20 determines a basic layout for the front and rear surfaces of the sheet (S106). More specifically, four images are arranged with a layout illustrated in any one of FIGS. 4 through 7 in accordance with the cutting positions determined in S105. In FIGS. 4 through 7, images to be printed on the rear surface are indicated as hatched images for an easy distinction between the front surface and the rear surface of the sheet. The cutting positions are indicated by bold lines.

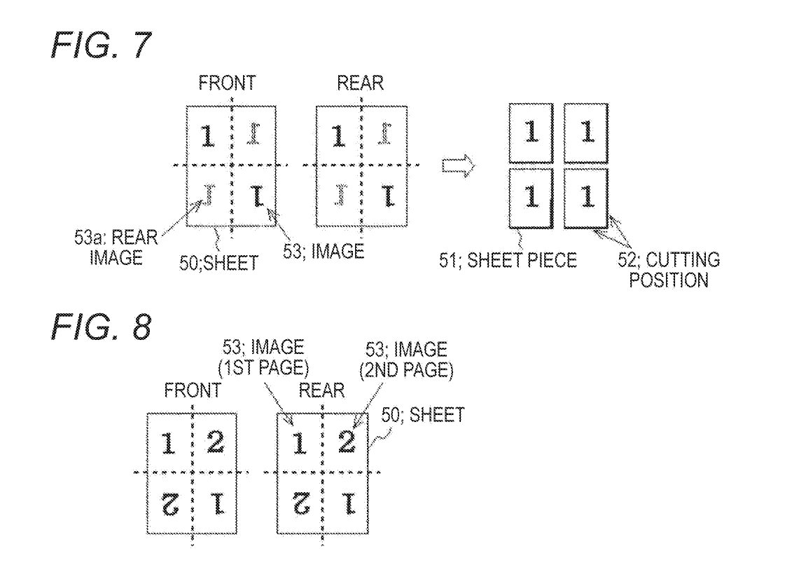

When the cutting positions on the left and upper sides of each image are desired, a layout is determined such that images are printed in the left-upper and right-lower areas of four areas of the sheet 50 divided in 2×2 for each of the front and rear surfaces of the sheet 50 as illustrated in FIG. 4. Moreover, the image in the upper area (left area) of the sheet 50 is rotated through 180 degrees. When the cutting positions on the right and upper sides of each image are desired, a layout is determined such that images are printed in the right-upper and left lower areas of the sheet 50 for each of the front and rear surfaces of the sheet 50 as illustrated in FIG. 5. Moreover, the image in the upper area (right area) of the sheet 50 is rotated through 180 degrees. When the cutting positions on the left and lower areas of each image are desired, a layout is determined such that images are printed in the right-upper and left-lower areas of the sheet 50 for each of the front and rear surfaces of the sheet 50 as illustrated in FIG. 6. Moreover, the image in the lower area (left area) of the sheet 50 is rotated through 180 degrees. When the cutting positions on the right and lower sides of each image are desired, a layout is determined such that images are printed in the left-upper and right-lower areas of the sheet 50 for each of the front and rear surfaces of the sheet 50 as illustrated in FIG. 7. Moreover, the image in the lower area (right area) of the sheet 50 is rotated through 180 degrees. When images for 2 pages (“1” and “2”) are printed on both the surfaces, a combination of the layouts illustrated in FIGS. 6 and 7 are used as illustrated in FIG. 8.

The imposition setting unit 27 of the printer controller 20 executes a determining process for determining the number of sheets for the job (S107). More specifically, the imposition setting unit 27 determines whether only one sheet is consumed or two or more sheets are consumed for one copy of the job, based on printing setting information such as the number of printing target pages, whether or not both side printing has been designated, and whether or not N-up layout has been designated. When both side printing is designated, for example, the number of sheets consumed for one copy of the job corresponds to the number obtained by dividing the number of the printing target pages by 2. When N-up layout is designated, the number of sheets consumed for one copy of the job corresponds to the number corresponds to the number obtained by dividing the number of printing target pages by N. When both side printing and N-up layout are both designated, the number of sheets consumed for one copy of the job corresponds to the number corresponds to the number obtained by dividing the number of printing target pages by 2×N.

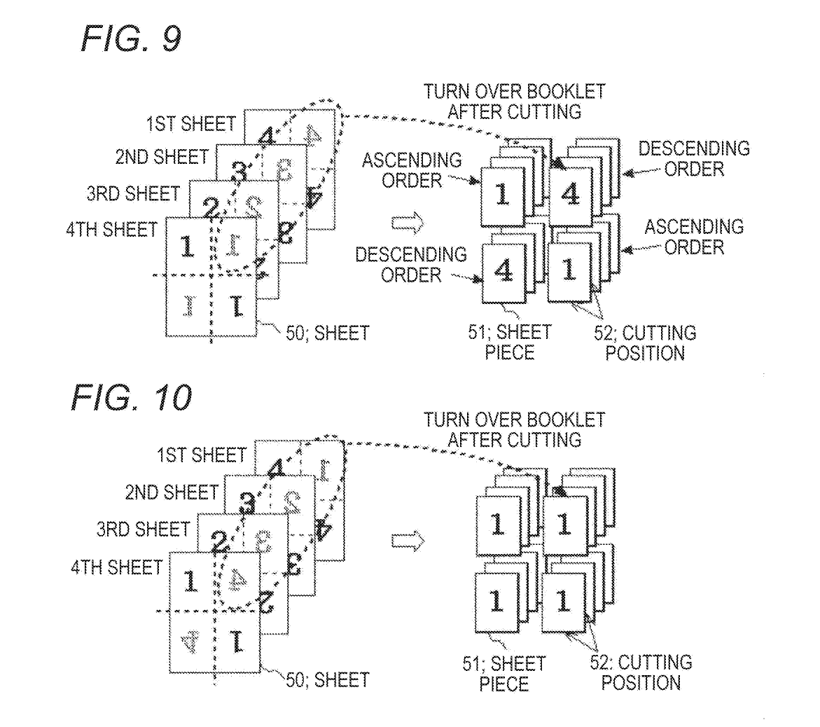

When the number of sheets consumed for one copy of the job is two or more (in other words, two or more sheets are needed for processing one copy of the printing job including a plurality of pages), the imposition setting unit 27 of the printer controller 20 performs a page order reversing process as necessary (S108). More specifically, when the printing job including a plurality of pages is processed with the layout determined in S106, page orders of respective booklets are not equalized (i.e., the page order of booklets printed on the rear surface is reversed when the booklets on the rear surface are turned over after cutting) as illustrated in FIG. 9. Accordingly, the order of the sheet pieces 51 within the booklet needs to be switched. In this example, therefore, the page order of the images printed on the rear surface is reversed as illustrated in FIG. 10. More specifically, the left-upper and the right-lower areas as viewed from the front of the figure (left-upper and right-lower areas of the front surface of the sheet 50) are sequentially printed from the last page. On the other hand, the right-upper and the left-lower areas as viewed from the front of the figure (left-upper and right-lower areas of the rear surface of the sheet 50) are sequentially printed from the top page. In this case, the page orders of all booklets are equalized, wherefore the necessity for switching the order of the sheet pieces 51 within each booklet after printing is eliminated.

Thereafter, the control unit 21 of the printer controller 20 transmits to the printer engine 30 the image data rasterized by the RIP unit 26, and the printing instruction information containing the layout information and the printing page order information determined by the imposition setting unit 27.

The imposition unit 35 of the printer engine 30 positions images based on the layout information and the printing page order information to generate printing image data (S109). The screening unit 36 performs the screening process for the printing image data (S110). The printing unit 37 prints the images subjected to screening (binary images) on the sheet (S111). Furthermore, the post-processing unit 38 cuts the sheet on which the images are formed when necessary.

According to the flow described above, the processes from determination of the cutting positions in S105, determination of the basic layout in S106, and up to the page order reversing process in S107 and S108 are executed on the printer controller 20 side. However, when the function of the imposition setting unit 27 of the printer controller 20 is performed by the control unit 31 or the imposition unit 35 of the printer engine 30, only the processes up to the rasterizing process in S103 are executed on the printer controller 20 side. In this case, the processes after step S103 are executed by the printer engine 30.

When the function of the imposition setting unit 27 of the printer controller 20 is performed by the control unit 11 or the printer driver 14 of the user terminal 10, the processes in S104 through S108 are executed by the user terminal 10 in this case, the processes from reception of the printing job containing the imposition setting information to the rasterizing process (S101 through S103) are executed by the printer controller 20, and the processes after the imposition process (S109) are executed by the printer engine 30 with reference to the imposition setting information.

According to the example described above, processing associated with margins of a sheet is not included in the flow. In case of a sheet containing equalized margins in the left and right areas, and equalized margins in the upper and lower areas, equalization of margins of each booklet is achievable by the imposition control described above. However, in case of a sheet containing different margins in the left and right areas or different margins in the upper and lower areas, positions of images vary for each booklet. In this case, the imposition setting unit 27 may adjust the positions of the images based on the difference in margins between the upper and lower areas, and the difference in margins between the left and right areas. For example, an case of different margins in the left and right areas, such as a left margin of 15 mm and a right margin of 10 mm of a sheet, the image positioned in the right area of the sheet may be shifted toward the center by 5 mm to unify the positions of the images for all the booklets.

Accordingly, when 4-repeat printing is designated, cutting positions for each booklet are equalized by determining the cutting positions relative to each image of a document, and determining a layout for the front and rear surfaces of a sheet based on the cutting positions thus determined. As a result, unification of cutting finishes is achievable for all booklets. When two or more sheets are consumed for one copy of a printing job, page orders of images are unified for each booklet by reversing the page order of the images printed on the rear surface. When settings of margins are different between the upper and lower areas of a sheet or between the left and right areas of the sheet, positions of images are unified for each booklet by shifting the images in accordance with the difference of the margin areas.

### EXAMPLE 2

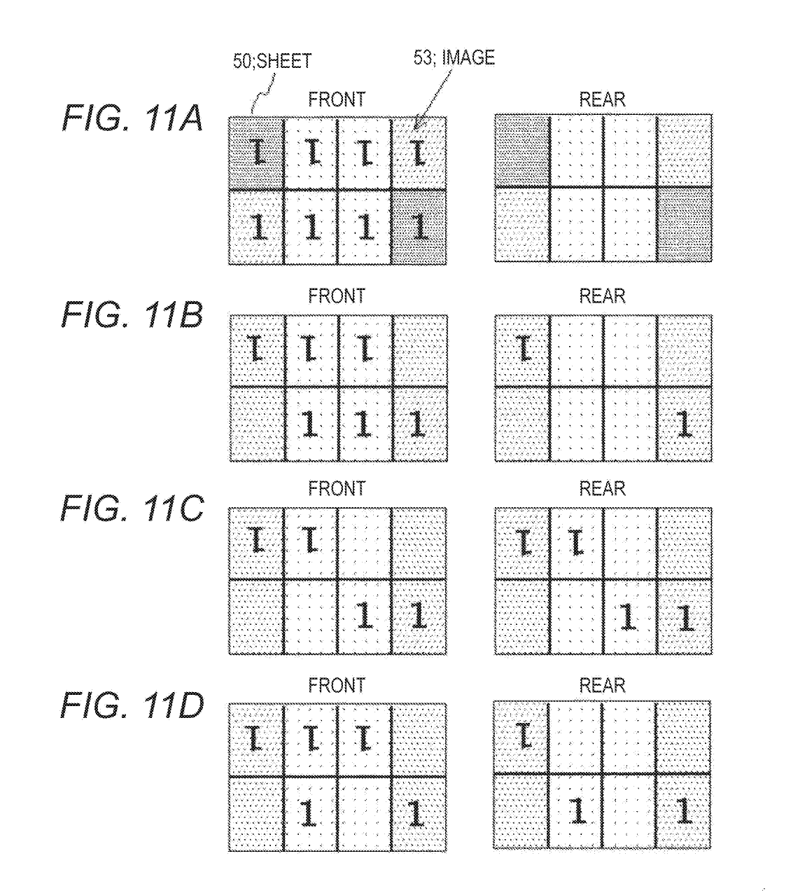

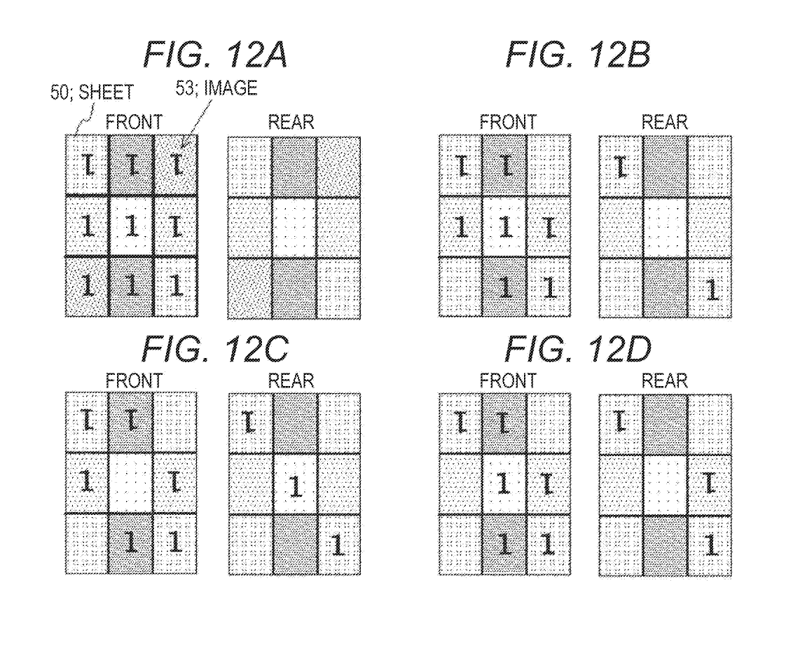

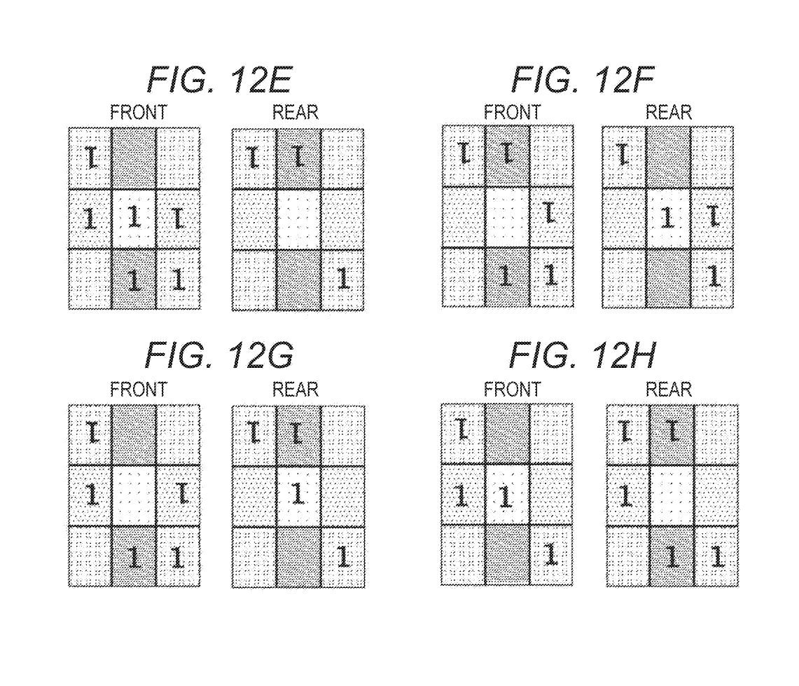

An imposition control program, an image processing apparatus, and an imposition control method according to Example 2 of the present invention are hereinafter described with reference to FIGS. 11A through 11D and FIGS. 12A through 12H. FIGS. 11A through 11D are views illustrating 8-repeat printing with comparison between a conventional method and the method according to Example 2. FIGS. 12A through 12H are views illustrating 9-repeat printing with comparison between a conventional method and the method according to Example 2.

In Example 1, specific examples of 4-repeat printing have been discussed. When a larger number of images than 2×2 are copied and positioned on a sheet, unification of cutting finishes of all images is difficult. However, it is possible to reduce one type of cutting finishes from all types of cutting finishes.

FIGS. 11A through 11D illustrate examples of a layout for positioning one image in each of 8 areas of a sheet divided in 2×4. FIG. 11A illustrates a conventional layout, while FIGS. 11B through 11D illustrate layouts according to Example 2. When images are positioned only on one surface of a sheet as in the conventional method as illustrated in FIG. 11A, three types of cutting position patters are produced for images even when the images in either the upper area or the lower area of the sheet are rotated through 180 degrees with respect to the images in the opposite area. (In the figure, identical patterns are indicated by identical types of hatching.) More specifically, the cutting positions lie on the left and upper sides for images located in the left-upper and right-lower areas of the sheet. The cutting positions lie on the right and upper sides for images located in the left-lower and right-upper areas of the sheet. The cutting positions lie on the left, right, and upper sides for images located in the four center areas of the sheet.

On the other hand, when the imposition control method for positioning images on the front surface and the rear surface of a sheet according to Example 2 is used, only two types of cutting position patterns are produced for images. For example, when the images 53 are positioned in four areas of left-upper, right-lower, and center portions on the front surface of the sheet 50, and in the left-upper and right-lower areas of the rear surface of the sheet 50 as illustrated in FIG. 11B, the cutting positions of the four images 53 located in the left-upper and right-lower areas of the front surface of the sheet 50 and in the left-upper and right-lower areas of the rear surface of the sheet 50 are unified into one type. Accordingly, reduction of one type of the cutting finishes is achievable.

According to the example illustrated in FIG. 11B, the four images 53 in the center areas are positioned on the front surface of the sheet 50. However, two of the four images 53 may be positioned on each of the front surface and the rear surface as illustrated in FIG. 11C. Alternatively, three of the four images 53 may be positioned on the front surface, while the remaining one of the four images 53 may be positioned on the rear surface as illustrated in FIG. 11D. The positions of the images on the front surface and the rear surface illustrated in FIGS. 11B through 11D may be switched to the opposite surface. According to the examples illustrated in FIGS. 11B through 11D, the images 53 are positioned on the left-upper and right-lower areas of the front surface of the sheet 50. However, the images 53 may be positioned in the left-lower and right-upper areas of the front surface of the sheet 50. According to the examples illustrated in FIGS. 11B through 11D, the images 53 in the upper areas of the sheet 50 are rotated through 180 degrees. However the images 53 in the lower areas of the sheet 50 may be rotated through 180 degrees, or the directions of the images 53 at the four corners and the directions of the images in the center areas may be made opposite to each other.

Accordingly, when the imposition control method according to Example 2 is used in 8-repeat printing, only two types of cutting finishes are produced by reduction of one type of cutting finishes. As a result, the appearances of the produced booklets improve.

FIGS. 12A through 12H illustrate examples of a layout for positioning one image in each of nine areas of a sheet divided in 3×3. FIG. 12A illustrates a conventional layout, while FIGS. 12B through 12H illustrate layouts according to Example 2. According to the conventional method which positions images only on one surface of a sheet as illustrated in FIG. 12A, five types of cutting position patterns are produced for the images 53 even when the images 53 are rotated through 180 degrees. More specifically, the cutting positions lie on the left and upper sides for the images 53 located in the left-upper and right-lower areas of the sheet 50. The cutting positions lie on the right and upper sides for the images 53 located in the left-lower and right-upper areas of the sheet 50. The cutting positions lie on the right, upper and lower sides for the images 53 located in the left-center and right-center areas of the sheet 50. The cutting positions lie on the left, right, and upper sides for the images 53 located in the upper-center and lower-center areas of the sheet 50. The cutting positions lie on the left, right, upper, and lower sides for the image 53 located in the center area of the sheet 50.

On the other hand, when the imposition control method which positions images on each of the front surface and the rear surface of a sheet according to Example 2 is used as illustrated in FIG. 12B, only four types of cutting position patterns are produced for images. For example, when the image 53 are positioned in each of seven areas of the left upper, right lower, left center, right center, upper center, lower center, and center of the front surface of the sheet 50, and positioned in each of the left upper and right lower areas of the rear surface of the sheet 50 as illustrated in FIG. 12B, the cutting positions for the four images 53 in the left-upper and right-lower areas of the front surface of the sheet 50 and in the left-upper and right-lower areas of the rear surface of the sheet 50 are unified into one type of cutting positions disposed in the left and upper areas. Accordingly, reduction of one type of cutting finishes is achievable.

According to the example illustrated in FIG. 12B, the five images 53 are positioned in the left-center, right-center, upper-center, lower-center, and center areas of the front surface of the sheet 50. However, the image 53 in the center area may be positioned on the rear surface as illustrated in FIG. 12C. Alternatively, the image 53 in the left-center or the right-center (left-center in this example) area may be positioned on the rear surface as illustrated in FIG. 12D, or the image 53 in the upper-center or lower-center (upper-center in this example) area may be positioned on the rear surface as illustrated in FIG. 12E. Moreover, the image 53 in the center area and the image 53 in the left-center or right-center (left-center in this example) areas may be positioned on the rear surface as illustrated in FIG. 12F, or the image 53 in the center area and the image 53 in the upper-center or lower-center (upper-center in this example) may be positioned on the rear surface as illustrated in FIG. 12G. Alternatively, the images 53 in the left-center and/or right-center (right-center in this example) area and the upper-center and/or lower-center (upper-center and lower-center in this example) areas may be positioned on the rear surface as illustrated in FIG. 12H. The positions of the images on the front surface and the rear surface illustrated in FIGS. 12B through 12H may be switched to the opposite surface. While the images 53 are positioned in the left-upper and right-lower areas of the front surface of the sheet 50 according to the examples illustrated in FIGS. 12B through 12H, the images 53 may be positioned in the left-lower and right-upper areas of the front surface of the sheet 50. According to the examples illustrated in FIGS. 12B through 12H, the images at the four corners have cutting positions in the upper side of the images, the images in the center-left and center-right areas have cutting positions in the right side of the images, and the images in the center-upper and center-lower areas have cutting positions in the upper side of the images. However, the images 53 may be rotated through 180 degrees such that these cutting positions come to the opposite sides.

Accordingly, when the imposition control method according to Example 2 is used in 9-repeat printing, only four types of cutting finishes are produced by reduction of one type of the cutting finishes. As a result, appearances of produced booklets improve.

While 8-repeat printing and 9-repeat printing have been discussed in Example 2 by way of example, positioning of images in 2×2 or more is generalized based on the following classifications on the assumption that m and n are 2 or larger integers: (1) positioning identical images in 2m×2n in the left-right direction and the up-down direction, respectively; (2) positioning identical images in 2m×2(n−1) in the left-right direction and the up-down direction, respectively; (3) positioning identical images in 2(m−1)×2n in the left-right direction and the up-down direction, respectively; and (4) positioning identical images in 2(m−1)×2(n−1) in the left-right direction and the up-down direction, respectively. The imposition control method of Example 2 is applicable to each of these cases.

The present invention is not limited to the examples described herein. The configuration and control specifically described in the respective examples may be modified in appropriate manners without departing from the scope of the present invention,

For example, while identical images are repeatedly positioned in the respective examples, unification of cutting finishes and reduction of cutting finish patterns are achievable even when a plurality of different images are positioned within a page.

The present invention is applicable to an imposition control program for controlling a layout of images in case of repeat printing for positioning a plurality of identical images on an identical sheet, a recording medium recording this imposition control program, an image processing apparatus (printer controller and printer engine) executing the imposition control program, and an imposition control method.

Although the present invention has been described and illustrated in detail, it is clearly understood that the same is by way of illustrated and example only and is not to be taken by way of limitation, the scope of the present invention being interpreted by terms of the appended claims.

What is claimed is:

1. A non-transitory recording medium storing a computer readable imposition control program operating in a device that processes a printing job for positioning identical images aligned in 2×2 or more on an identical sheet and cutting the sheet between the respective images to produce printed materials each of which contains the corresponding single image, the program causing the device to execute:
a first process for determining a layout of the plurality of images on each of a front surface and a rear surface of the sheet; and
a second process for generating printing instruction information for allowing a printing unit to execute printing the plurality of images on the front surface and the rear surface of the sheet in accordance with the layout determined in the first process, wherein
the first process positions the image in a predetermined direction at one corner in a particular diagonal direction on the front surface of the sheet, and positions the image rotated through 180 degrees at the other corner in the particular diagonal direction on the front surface of the sheet, and
the first process positions the image in the predetermined direction at the one corner in the particular diagonal direction on the rear surface of the sheet, and positions the image rotated through 180 degrees at the other corner in the other corner in the particular diagonal direction on the rear surface of the sheet.

2. The non-transitory recording medium storing a computer readable imposition control program according to claim 1, wherein, when the single image is positioned in each of four areas of the sheet divided in 2×2, the first process positions the image in each of two areas in left-upper and right-lower areas, or left-lower and right-upper areas in a diagonal direction on each of the front surface and the rear surface of the sheet, and rotates the image positioned in one of the two areas in the diagonal direction through 180 degrees with respect to the image positioned in the other of the two areas.

3. The non-transitory recording medium storing a computer readable imposition control program according to claim 1, wherein,
when the single image is positioned in each of eight areas of the sheet divided in 2×4, the first process positions the image in each of two areas in left-upper and right-lower areas, or left-lower and right-upper areas in a diagonal direction on each of the front surface and the rear surface of the sheet, and rotates the image positioned in one of the two areas in the diagonal direction through 180 degrees with respect to the image positioned in the other of the two images, and
the first process positions the images in the four areas other than the left-upper, right-lower, left-lower, and right-upper areas on either the front surface or the rear surface, and rotates the images positioned in one of two divisions of the sheet through 180 degrees with respect to the images positioned in the other of the two divisions.

4. The non-transitory recording medium storing a computer readable imposition control program according to claim 1, wherein,
when the single image is positioned in each of nine areas of the sheet divided in 3×3, the first process positions the image in each of two areas in left-upper and right-lower, or left-lower and right-upper areas in a diagonal direction on each of the front surface and the rear surface of the sheet, and rotates the image positioned in one of the two areas in the diagonal direction through 180 degrees with respect to the image positioned in the other of the two areas,
the first process positions the images in the four areas other than the left-upper, right-lower, left-lower, right-upper, and center areas on either the front surface or the rear surface, and rotates the image positioned in one end division of three divisions of the sheet through 180 degrees with respect to the image positioned in the other end division of the three divisions, and
the first process positions the image in the center area of either the front surface of the rear surface of the sheet.

5. The non-transitory recording medium storing a computer readable imposition control program according to claim 1, wherein, when binding is designated in the printing job, the first process determines cutting positions of the images based on a binding position of the binding, and determines the layout of the images based on the cutting positions.

6. The non-transitory recording medium storing a computer readable imposition control program according to claim 1, wherein, when two or more sheets are necessary for processing one copy of the printing job including a plurality of pages, the first process switches the page order of the identical images positioned on the front surface of each sheet or the page order of the identical images positioned on the rear surface of each sheet such that the respective page orders become opposite to each other.

7. An image processing apparatus that processes a printing job for positioning identical images aligned in 2×2 or more on an identical sheet and cutting the sheet between the respective images to produce printed materials each of which contains the corresponding single image, the image processing apparatus comprising:
a rasterizing unit that analyzes the printing lob to generate the images for each page; and
an imposition setting unit that determines a layout of the plurality of images of an identical page on each of a front surface and a rear surface of the sheet, and generates printing instruction information for allowing printing of the plurality of images on the front surface and the rear surface of the sheet in accordance with the layout determined by the rasterizing unit, wherein
at the time of determination of the layout of the plurality of images, the imposition setting unit positions the image in a predetermined direction at one corner in a particular diagonal direction on the front surface of the sheet, and positions the image rotated through 180 degrees at the other corner in the particular diagonal direction on the front surface of the sheet, and
at the time of determination of the layout of the plurality of images, the imposition setting unit positions the image in the predetermined direction at the one corner in the particular diagonal direction on the rear surface of the sheet, and positions the image rotated through 180 degrees at the other corner in the other corner in the particular diagonal direction on the rear surface of the sheet.

8. The image processing apparatus according to claim 7, wherein, when the single image is positioned in each of four areas of the sheet divided in 2×2, the imposition setting unit positions the image in each of two areas in left-upper and right-lower areas, or left-lower and right-upper areas in a diagonal direction on each of the front surface and the rear surface of the sheet, and rotates the image positioned in one of the two areas in the diagonal direction through 180 degrees with respect to the image positioned in the other of the two areas.

9. The image processing apparatus according to claim 7, wherein,
when the single image is positioned in each of eight areas of the sheet divided in 2×4, the imposition setting unit positions the image in each of two areas in left-upper and right-lower areas, or left-lower and right-upper areas in a diagonal direction on each of the front surface and the rear surface of the sheet, and rotates the image positioned in one of the two areas in the diagonal direction through 180 degrees with respect to the image positioned in the other of the two areas, and
the imposition setting unit positions the images in the four areas other than the left-upper, right-lower, left-lower, and right-upper areas on either the front surface or the rear surface, and rotates the images positioned in one of two divisions of the sheet through 180 degrees with respect to the images positioned in the other of the two divisions.

10. The image processing apparatus according to claim 7, wherein,
when the single image is positioned in each of nine areas of the sheet divided in 3×3, the imposition setting unit positions the image in each of two areas in left-upper and right-lower, or left-lower and right-upper areas in a diagonal direction on each of the front surface and the rear surface of the sheet, and rotates the image positioned in one of the two areas in the diagonal direction through 180 degrees with respect to the image positioned in the other of the two areas,
the imposition setting unit positions the images in the four areas other than the left-upper, right-lower, left-lower, right-upper, and center areas on either the front surface or the rear surface, and rotates the image positioned in one end division of three divisions of the sheet through 180 degrees with respect to the image positioned in the other end division of the three divisions, and
the imposition setting unit positions the image in the center area of either the front surface of the rear surface of the sheet.

11. The image processing apparatus according to claim 7, wherein, when binding is designated in the printing job, the imposition setting unit determines cutting positions of the images based on a binding position of the binding, and determines the layout of the images based on the cutting positions.

12. The image processing apparatus according to claim 7, wherein, when two or more sheets are necessary for processing one copy of the printing job including a plurality of pages, the imposition setting unit switches the page order of the identical images positioned on the front surface of each sheet or the page order of the identical images positioned on the rear surface of each sheet such that the respective page orders become opposite to each other.

13. The image processing apparatus according to claim 7, further comprising a printing unit that prints the plurality of images on each of the front surface and the rear surface of the sheet in accordance with the printing instruction information.

14. The image processing apparatus according to claim 13, further comprising a post-processing unit that cuts the sheet between the respective images after the images are printed on the front surface and the rear surface of the sheet.

15. An imposition control method for a device that processes a printing job for positioning identical images aligned in 2×2 or more on identical sheet and cutting the sheet between the respective images to produce printed materials each of which contains the corresponding single image, the method comprising:
a first process for determining a layout of the plurality of images on each of a front surface and a rear surface of the sheet; and
a second process for generating printing instruction information for allowing a printing unit to execute printing the plurality of images on the front surface and the rear surface of the sheet in accordance with the layout determined in the first process, wherein
the first process positions the image in a predet.ermined direction at one corner in a particular diagonal direction on the front surface of the sheet, and positions the image rotated through 180 degrees at the other corner in the particular diagonal direction on the front surface of the sheet, and
the first process positions the image in the predetermined direction at the one corner in the particular diagonal direction on the rear surface of the sheet, and positions the image rotated through 180 degrees at the other corner in the other corner in the particular diagonal direction on the rear surface of the sheet.
